(19) United States
(12) Patent Application Publication
(10) Pub. No.: US 2023/0386251 A1
(43) Pub. Date: Nov. 30, 2023

(54) AUTHENTICATION METHOD, STORAGE MEDIUM, AND INFORMATION PROCESSING DEVICE

(71) Applicant: Fujitsu Limited, Kawasaki-shi (JP)

(72) Inventor: Takahiro AOKI, Kawasaki (JP)

(73) Assignee: Fujitsu Limited, Kawasaki-shi (JP)

(21) Appl. No.: 18/448,699

(22) Filed: Aug. 11, 2023

Related U.S. Application Data
(63) Continuation of application No. PCT/JP2021/008494, filed on Mar. 4, 2021.

(51) Int. Cl. G06V 40/12; G06V 40/14; G06F 21/32

(52) U.S. Cl. CPC G06V 40/1365; G06V 40/1347; G06V 40/14; G06F 21/32

(57) ABSTRACT

An authentication method for a computer to execute a process includes when receiving biometric information from a user, specifying a plurality of feature points that correspond to feature points included in the received biometric information, from among feature points included in a plurality of registered pieces of biometric information; and determining a degree of influence, on an authentication result of the user, of similarity between features of the feature points included in the received biometric information and each of the specified plurality of feature points, based on the similarity between each of the specified plurality of feature points and each of the feature points included in the received biometric information.

### CROSS-REFERENCE TO RELATED APPLICATION

This application is a continuation application of International Application PCT/JP2021/008494 filed on Mar. 4, 2021 and designated the U.S., the entire contents of which are incorporated herein by reference.

### FIELD

The present case relates to an authentication method, a storage medium, and an information processing device.

### BACKGROUND

In biometric authentication, an authentication scheme using a plurality of parts included in biometric information is disclosed (see, for example, Patent Document 1).
Patent Document 1: Japanese Laid-open Patent Publication No. 2016-207216

### SUMMARY

According to an aspect of the embodiments, an authentication method for a computer to execute a process includes when receiving biometric information from a user, specifying a plurality of feature points that correspond to feature points included in the received biometric information, from among feature points included in a plurality of registered pieces of biometric information; and determining a degree of influence, on an authentication result of the user, of similarity between features of the feature points included in the received biometric information and each of the specified plurality of feature points, based on the similarity between each of the specified plurality of feature points and each of the feature points included in the received biometric information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating feature points and features;

FIG. 2 is a diagram illustrating feature point pairs;

FIG. 3 is a diagram illustrating feature scores;

FIG. 4 is a diagram illustrating a narrowing process;

FIG. 5 is a diagram illustrating a feature point matching rate;

FIG. 6 is a block diagram illustrating an overall configuration of an information processing device according to a first embodiment;

FIG. 7 is a flowchart representing an example of a biometric registration process;

FIG. 8 is a flowchart representing an example of a biometric authentication process;

FIG. 9 is a block diagram illustrating an overall configuration of an information processing device according to a second embodiment;

FIG. 10 is a flowchart representing an example of a biometric authentication process according to the second embodiment; and

FIG. 11 is a diagram illustrating a hardware configuration.

### DESCRIPTION OF EMBODIMENTS

Not all parts are effective in terms of collation. That is, if there are feature points that commonly appear in many pieces of data, the feature points act as noise in collation, and there is a possibility that the authentication accuracy is deteriorated.

In one aspect, an object of the present invention is to provide an authentication method, an authentication program, and an information processing device capable of enhancing authentication accuracy.

The authentication accuracy may be enhanced.

In biometric authentication, biometric information on a user is acquired using a sensor such as a camera, collation data is generated by transforming the acquired biometric information into a biometric feature that can be collated, and the generated collation data is collated with registration data. For example, in a biometric authentication scheme using feature points, a plurality of feature points suitable for biometric authentication is selected from an image or the like of a living body part acquired by a sensor, biometric features are calculated from images in the neighborhood of the feature points, and the biometric features for each of the feature points are collated, whereby the identity is confirmed.

Similarity scores (hereinafter, this will be referred to as feature scores) are found for each feature point by collating biometric features for every corresponding feature points between the collation data and the registration data, and furthermore, the feature scores of the plurality of feature points are integrated. The integrated feature scores will be hereinafter referred to as a final score. By verifying whether or not the final score is higher than a predefined identity verification threshold value, the identity can be confirmed.

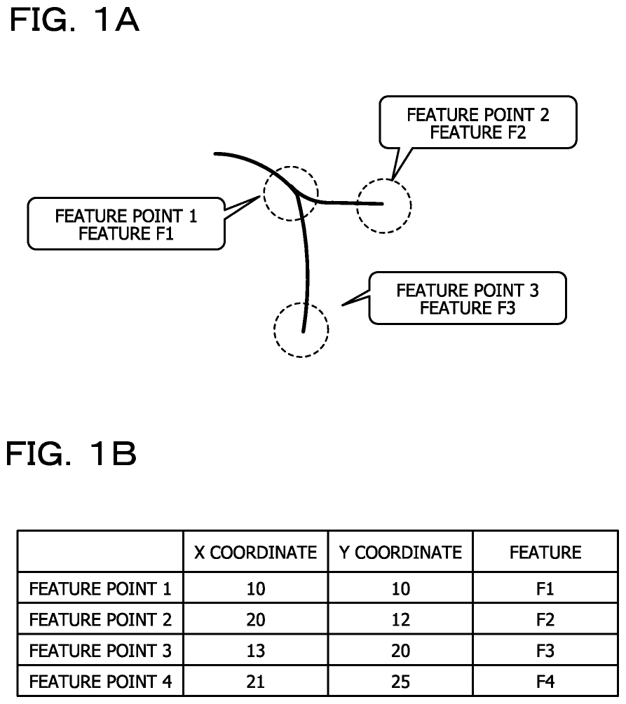

For example, as illustrated in FIGS. 1A and 1B, a branch point, an end point, and the like of a fingerprint or a vein are extracted as “feature points”, the coordinates (X, Y) of each feature point are extracted, and a feature is calculated from a neighboring image of each feature point. The neighboring image refers to an image including a feature point and having a smaller area than the acquired biometric image.

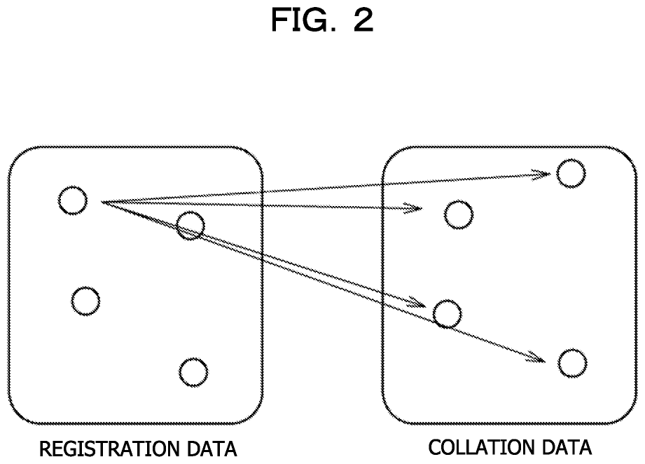

Various schemes are possible for the collation using feature points, and an example will be mentioned below. As illustrated in FIG. 2, the feature included in the registration data is compared with the feature included in the collation data, and a feature point pair is found. Note that it is assumed that position alignment has already been roughly carried out on both of the registration data and the collation data. The position alignment can be performed using the shape of the living body part (such as the outer shape of the palm or the outer shape of the finger as an example), or the like.

First, a loop is performed on the registered feature points to search for the most similar feature point at the collation data side. Here, in the search for the feature point pair, two indexes of (1) a spatial distance and (2) a feature score are adopted. As for the spatial distance, the condition that a distance between the coordinates (Xri, Yri) of the feature point of interest at the registration data side and the coordinates (Xii, Yii) of the feature point at the collation data side is equal to or less than a predetermined threshold value Rth is adopted. The feature points having a predetermined spatial distance or less are searched to retrieve the feature point at the collation data side having the most comparable feature. Specifically, a feature score representing how much the features are comparable to each other is calculated, and a collation point that gives the maximum score is found.

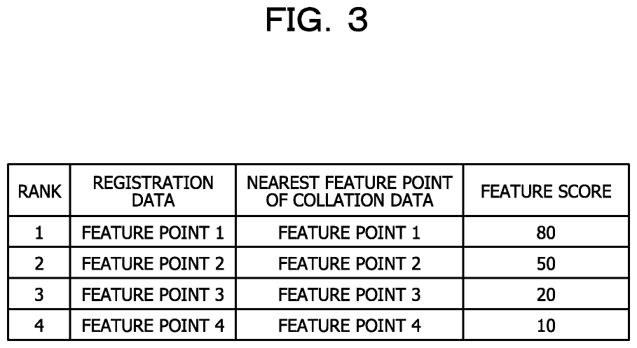

Next, as illustrated in FIG. 3, the final score is found from the results of all the obtained feature point pairs. For example, the feature point pairs are sorted by feature score, an average of top scores (for example, the scores ranked in the top ten) is found, and the found average is treated as the final score.

In biometric authentication, there are 1:1 authentication in which collation is performed after the collation object registration data is specified by inputting an identifier (ID) beforehand, and 1:N authentication in which no ID is input and collation is performed with the registration data of N persons without specifying the collation object registration data. High authentication accuracy is desired in any authentication scheme, but in the 1:N authentication, high authentication accuracy according to the number N of registered items is desired. This is because as N increases, the number of collations between others increases, and the probability of acceptance of others rises. Even when the accuracy is sufficient in the 1:1 authentication, still higher accuracy is desired in the 1:N authentication. In particular, as N has a larger scale such as 100,000 and 1 million, higher accuracy is desired.

As a method of raising the authentication accuracy, there is a scheme of using the extent of effectiveness for collation for each feature point. Here, the feature point is obtained by selecting a characteristic feature point from the image, but not all the feature points are effective in terms of collation. That is, if there are feature points that commonly appear in many pieces of data, the feature points act as noise in collation. Here, there are various factors that can cause the feature points to commonly appear.

For example, noise unique to the sensor is exemplified. For example, when illumination is used to acquire an authentication image, there is a case where a pseudo feature point is easily detected at a predetermined place due to the influence of illumination distribution. Specifically, a pseudo feature point is likely to appear easily in a boundary region between a region with high illumination intensity and a region with low illumination intensity. For example, in non-contact authentication such as vein authentication, a pseudo feature point sometimes appears due to surface reflection at a living body part, or the like. Alternatively, a common feature point can appear in all data due to the influence of a scratch or distortion of the lens. Alternatively, a feature point also can sometimes appear at a particular position in all users for a reason unique to biometric information to be authenticated.

Usually, such a common feature point can be detected and excluded by performing large-scale data collection and evaluation. However, such processing is not carried out because data collection and evaluation are burdensome and costly.

Hereinafter, an authentication method, an authentication program, and an information processing device capable of enhancing the authentication accuracy of 1:N authentication will be described. Each of the following forms of embodiment may exert significant effectiveness, particularly in large-scale 1:N authentication.

First, the principle will be described. When the 1:N authentication is executed, a feature point matching rate Cᵢ of each feature point extracted from the collation data is calculated and used for the authentication. The feature point matching rate Cᵢ is a value calculated for each feature point Fᵢ of the collation data and is a percentage at which a matching feature point exists with respect to the number N′ of pieces of registration data.

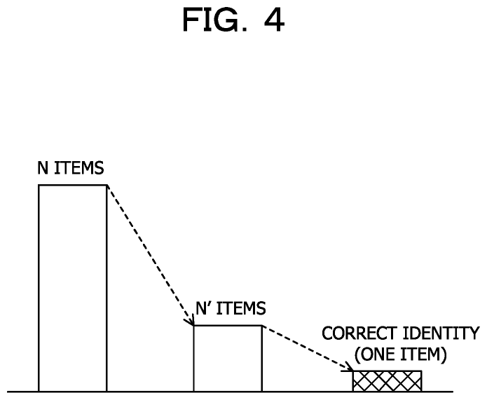

N′ may be equal to N or may be smaller than N. For example, when a narrowing process is performed, N′ is made equal to or less than N or less than N. FIG. 4 is a diagram illustrating the narrowing process. N represents the number of registered users (strictly, the number of pieces of registration data). The narrowing process uses a processing scheme capable of high-speed arithmetic operations although the authentication accuracy is not high. Through this narrowing process, the collation objects of the collation data can be narrowed down from N to N′. By narrowing down the collation objects, when time-consuming but highly accurate collation is performed for collation with respect to N′ pieces, both of decrease in processing time and high authentication accuracy may be achieved.

The number N′ of pieces of registration data for which the feature point matching rate Cᵢ is to be calculated is made equal to or less than N when the calculation is performed on the registration data after the narrowing process or the like is performed. The case where N′<N holds can be, for example, a case where the registration data regarded as candidates for the correct identity is excluded by the narrowing process or a case where the registration data is excluded from candidates for the correct identity because the calculated final score is lower than a predetermined threshold value.

Here, as described with reference to FIG. 2, the “comparable feature point” means a feature point whose spatial distance is equal to or less than the predetermined threshold value Rth and whose feature score Sᵢ is higher than a predetermined threshold value Sth. The number CNᵢ of comparable feature points Fᵢ is found and divided by the number N′ of pieces of feature data to be calculated as in following formula (1), whereby the feature point matching rate Cᵢ is calculated. A number given to a feature point extracted from the collation data is denoted by “i” and is a number satisfying 1≤i≤m (total number of feature points).

$$[ Mathematical Formula 1 ]$$

$${C}_{i} = \frac{{CN}_{i}}{{N}^{′}} \qquad ( 1 )$$

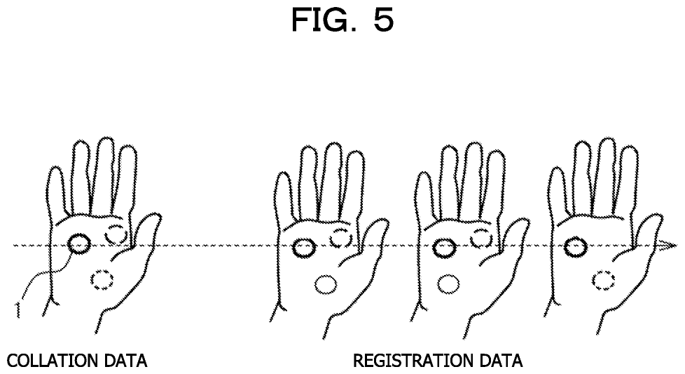

For example, in the example in FIG. 5, a feature point 1 of the collation data matches three pieces of registration data of three persons. Therefore, in the example in FIG. 5, the feature point matching rate C₁ is 3/3=1.0.

The authentication accuracy is raised by setting a weight Wᵢ for score computation for the feature point Fᵢ according to this feature point matching rate Cᵢ. A feature point having a high feature point matching rate Cᵢ is a feature point matching in many pieces of registration data, and such a feature point can be deemed as an ordinary feature. By lowering the weight of such a feature point with respect to the final score, the authentication accuracy may be improved.

When attention is paid to a certain feature point Fᵢ of the collation data, a feature point that matches many pieces of registration data has a low degree of effectiveness in identification. That is, since the feature point matching many pieces of registration data (=having a high feature point matching rate Cᵢ) is an ordinary feature, the effect of improving the authentication accuracy may be obtained by lowering the extent of influence of such a feature point on the final score.

Here, as a method of lowering the extent of influence on the collation of the feature point having a high feature point matching rate Cᵢ, there are a method of lowering the weight Wᵢ for the final score, a method of excluding the feature point from the collation when the feature point matching rate Cᵢ exceeds a predetermined value, and the like. For example, as the feature point matching rate Cᵢ is higher, the weight of the feature score Sᵢ of the feature point Fᵢ is made smaller. In addition, the feature point matching rate Cᵢ can also be reflected by excluding a feature point having a feature point matching rate Cᵢ higher than a predetermined threshold value or top feature points having a higher feature point matching rate Cᵢ (example: feature points ranked in the top 10%).

According to the above approach, the degree of influence of the feature score Sᵢ on the final score can be determined based on the similarity between the feature of each feature point Fᵢ and the feature of the corresponding feature point of the registration data. Therefore, for example, the feature points that commonly appear in many pieces of data can be dynamically excluded, and the authentication accuracy may be enhanced.

In addition, by using the number CNᵢ of the feature points Fᵢ of which the feature scores Sᵢ are higher than the predetermined threshold value Sth or the feature point matching rate Cᵢ, the feature points that commonly appear in many pieces of data can be more dynamically excluded, and the authentication accuracy may be further raised. The feature points common to many pieces of data can appear due to various factors, but usually, a large amount of data is collected and inspected to recognize the feature points, and the recognized feature points are subjected an exclusion process or the like. However, such processing has a disadvantage that enormous time and cost are involved. In the above approach, in large-scale 1:N authentication, inspection with a large amount of data is dynamically executed at the time of authentication, whereby the authentication accuracy may be enhanced without involving much cost. As described earlier, in large-scale 1:N authentication, as N increases more, still higher authentication accuracy is expected. Meanwhile, in the present case, as N increases more, the feature point matching rate Cᵢ can be calculated for a larger number of registration data, and the reliability of the feature point matching rate Cᵢ rises. As a result, a higher authentication accuracy improvement effect may be obtained.

### First Embodiment

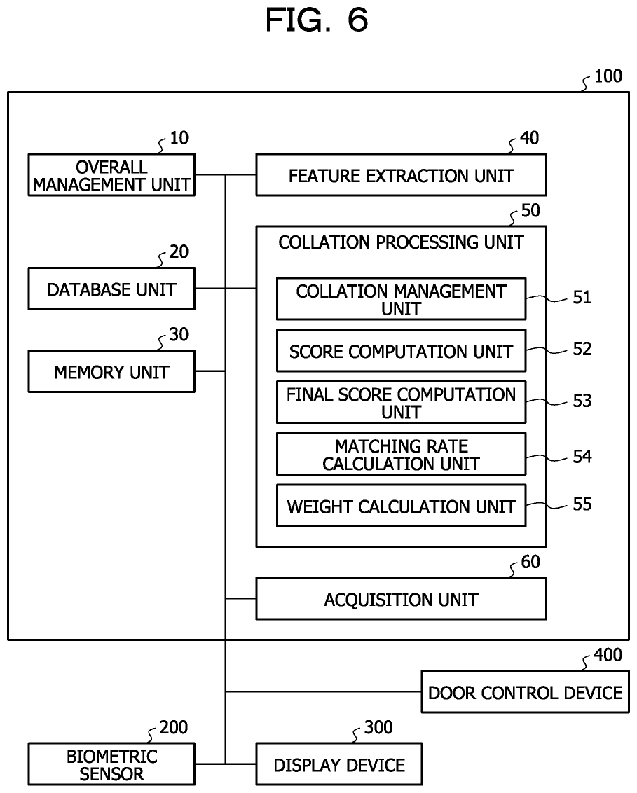

FIG. 6 is a block diagram illustrating an overall configuration of an information processing device 100 according to a first embodiment. As illustrated in FIG. 6, the information processing device 100 includes an overall management unit 10, a database unit 20, a memory unit 30, a feature extraction unit 40, a collation processing unit 50, an acquisition unit 60, and the like. The collation processing unit 50 includes a collation management unit 51, a score computation unit 52, a final score computation unit 53, a matching rate calculation unit 54, a weight calculation unit 55, and the like.

The overall management unit 10 controls working of each unit of the information processing device 100. The database unit 20 stores the registration data. The memory unit 30 is a storage unit that temporarily stores the collation data, a processing result, and the like.

The acquisition unit 60 acquires the biometric image from a biometric sensor 200. The biometric sensor 200 is an image sensor or the like capable of acquiring a biometric image. For example, when the biometric sensor 200 is a fingerprint sensor, the biometric sensor 200 is an optical sensor that acquires fingerprints of one or more fingers arranged in contact with a reading surface and acquires a fingerprint using light, a capacitance sensor that acquires a fingerprint using a difference in a capacitance, or the like. When the biometric sensor 200 is a vein sensor, the biometric sensor 200 is a sensor that acquires palm veins in a non-contact manner and, for example, images veins under the skin of the palm using near infrared rays that are highly permeable to human bodies. For example, the vein sensor includes a complementary metal oxide semiconductor (CMOS) camera or the like. In addition, an illumination or the like that emits light including near infrared rays may be provided.

The collation processing unit 50 outputs a collation processing result to a display device 300. The display device 300 displays a processing result of the information processing device 100. The display device 300 is a liquid crystal display device or the like. A door control device 400 is a device that opens and closes a door when, for example, the authentication is successful in the authentication process of the information processing device 100.

(Biometric Registration Process)

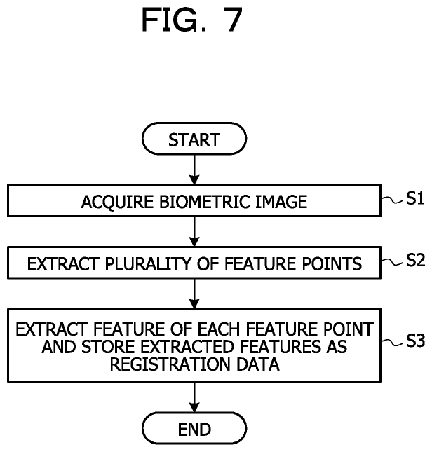

FIG. 7 is a flowchart representing an example of a biometric registration process. The biometric registration process is a process performed when a user registers the registration data in advance. As illustrated in FIG. 7, the acquisition unit 60 acquires a biometric image from the biometric sensor 200 (step S1). Next, the feature extraction unit 40 extracts a plurality of feature points from the biometric image captured in step S1 (step S2). Next, the feature extraction unit 40 extracts a feature of each feature point extracted in step S2 and stores the extracted features in the database unit 20 as the registration data (step S3). Here, for the features, various schemes such as scale-invariant feature transform (SIFT) and histograms of oriented gradients (HOG) can be used. By performing the biometric registration process on the N users, the registration data of the N users can be registered in advance.

(Biometric Authentication Process)

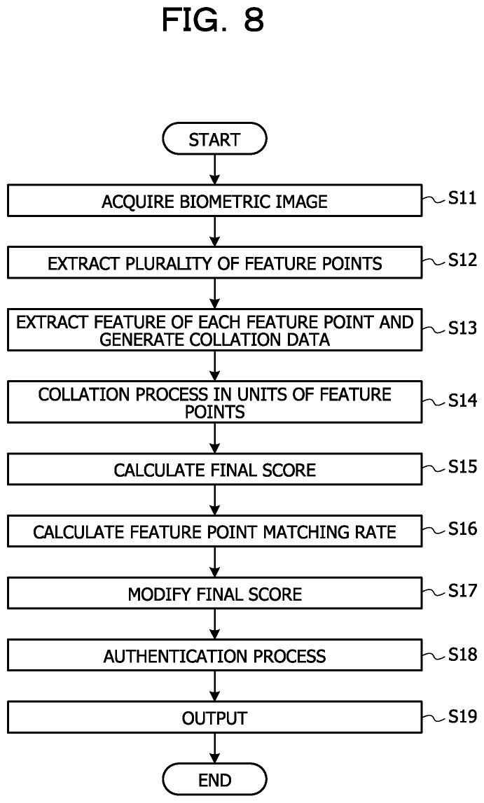

FIG. 8 is a flowchart representing an example of a biometric authentication process. The biometric authentication process is a process performed in a scene where the identity has to be confirmed. As illustrated in FIG. 8, the acquisition unit 60 acquires a biometric image from the biometric sensor 200 (step S11). Next, the feature extraction unit 40 extracts a plurality of feature points from the biometric image acquired in step S11 (step S12). Next, the feature extraction unit 40 extracts a feature of each feature point extracted in step S12 and generates collation data (step S13).

Next, the score computation unit 52 calculates the feature score Sᵢ of each feature point of the collation data, by performing a collation process in units of feature points between the collation data and each piece of the registration data registered in the database unit 20 (step S14). In the present embodiment, as an example, the collation objects are narrowed down from N to N′ by performing the above-described narrowing process. In addition, the collation process in units of feature points is performed between feature points whose spatial distance is equal to or less than the predetermined threshold value Rth between the collation data and each piece of the registration data.

Next, the final score computation unit 53 calculates the final score for each piece of the registration data (step S15). For example, the feature point pairs are sorted by feature score, an average of top scores (for example, the scores ranked in the top ten) is found, and the found average is treated as the final score.

Next, the matching rate calculation unit 54 calculates the feature point matching rates Cᵢ for each feature point of the collation data (step S16). In step S16, by saving the correspondence relationship between the registered feature point and the collation feature point, the processing can be speeded up. For example, as illustrated in FIG. 3, feature point pair information calculated in the collation process in units of feature points is held. Although a loop has to be repeated by the number of registered feature point×the number of collation feature points and it involves time to search for a feature point pair, the calculation of the feature point matching rates Cᵢ can be executed at higher speed by saving the feature point pair information.

Next, the weight calculation unit 55 calculates the weight Wᵢ of each feature point from the feature point matching rate Cᵢ of each feature point calculated in step S16. For example, the weight calculation unit 55 calculates the weight Wᵢ in accordance with following formula (2), using the feature point matching rate Cᵢ and a positive constant α. The weight Wᵢ is a weight for the feature point Fᵢ. Next, the final score computation unit 53 modifies the final score in step S15, using the calculated weight Wᵢ (step S17). For example, the final score computation unit 53 modifies the final score for each piece of the registration data in accordance with following formula (3).

$$[ Mathematical Formula 2 ]$$

$${W}_{i} = {e}^{- α {C}_{i}} \qquad ( 2 )$$

$$[ Mathematical Formula 3 ]$$

$$SCORE = \frac{{\sum }_{i}^{N} {W}_{i} {S}_{i}}{{\sum }_{i}^{N} {W}_{i}} \qquad ( 3 )$$

Next, the collation management unit 51 performs an authentication process by verifying whether or not each final score modified in step S17 is equal to or higher than a threshold value (step S18). For example, the collation management unit 51 specifies that the user undergoing the collation process is the user of the registration data whose final score is equal to or higher than the threshold value. The display device 300 displays the verification result in step S18 (step S19). For example, when the authentication process is successful, the door control device 400 opens and closes the door.

According to the present embodiment, the degree of influence of the feature score Sᵢ on the final score can be determined based on the similarity between the feature of each feature point Fᵢ and the feature of the corresponding feature point of the registration data. Therefore, for example, the feature points that commonly appear in many pieces of data can be dynamically excluded, and the authentication accuracy may be enhanced. In addition, by using the number CNᵢ of the feature points Fᵢ of which the feature scores Sᵢ are higher than the predetermined threshold value Sth or the feature point matching rate Cᵢ, the feature points that commonly appear in many pieces of data can be more dynamically excluded, and the authentication accuracy may be further raised.

### Second Embodiment

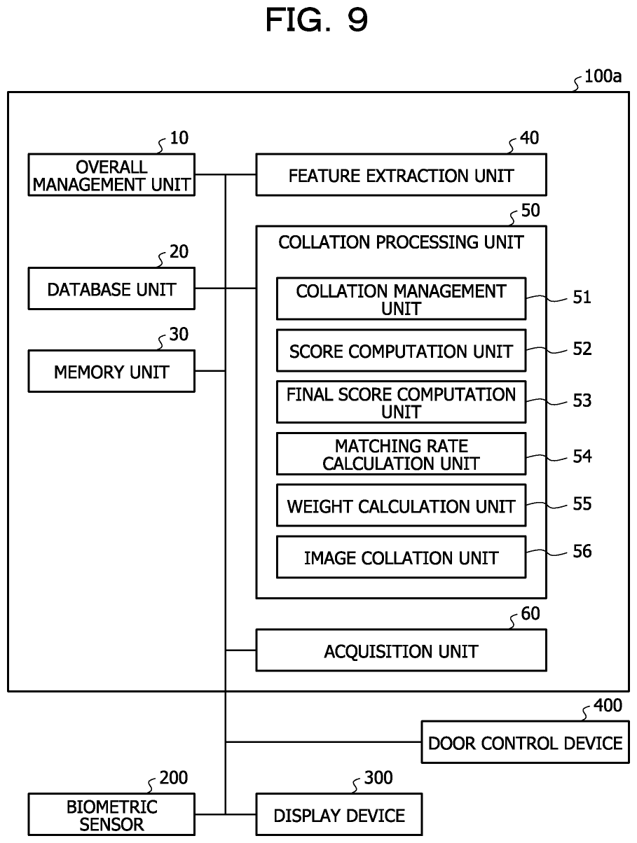

FIG. 9 is a block diagram illustrating an overall configuration of an information processing device 100a according to a second embodiment. As illustrated in FIG. 9, the information processing device 100a is different from the information processing device 100 of the first embodiment in that a collation processing unit 50 further includes an image collation unit 56.

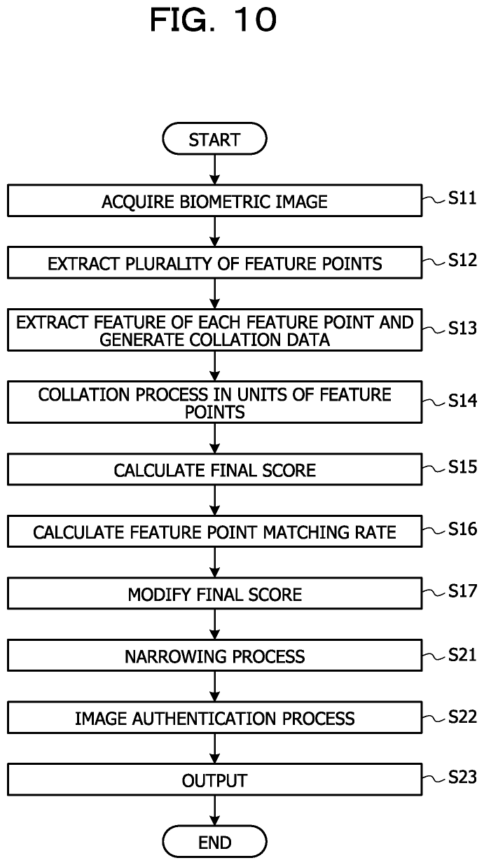

FIG. 10 is a flowchart representing an example of a biometric authentication process according to the present embodiment. As illustrated in FIG. 10, steps S11 to S17 are similar to the steps in FIG. 8. After the execution of step S17, the image collation unit 56 performs a narrowing process using the final scores modified in step S17 (step S21). In the narrowing process, the modified final scores calculated for the N pieces of the registration data are sorted, and the top N′ pieces of the registration data are selected as candidates for the correct identity. At this time, a threshold value for use in narrowing down (which may be different from the threshold value for use in collation according to the first embodiment) may be set for the final scores, and only registration data equal to or higher than the threshold value may be treated as candidates for the correct identity. This enables to narrow down the number N of pieces of the registration data to the number N′ of pieces of the registration data.

Next, after reflecting the feature point matching rates Cᵢ, the image collation unit 56 performs an image authentication process between the narrowed N′ pieces of the registration data and the biometric image acquired in step S11 (step S22). For example, a collation management unit 51 specifies that the user undergoing an image collation process is the user of the registration data whose final score is equal to or higher than the threshold value. The display device 300 displays the verification result in step S22 (step S23). For example, when the authentication process is successful, the door control device 400 opens and closes the door.

Note that, in the image collation process, an image vector of the registration data is assumed as F (vector element=fᵢ), and an image vector of the biometric image acquired in step S11 is assumed as G (vector element=At this time, similarity S_{img} between the images is found as follows (corresponding to an arithmetic operation for finding cos θ between vectors).

$$[ Mathematical Formula 4 ]$$

$${S}_{img} = \frac{{\sum }_{i}^{N} {f}_{i} {g}_{i}}{\vert F \vert \vert G \vert} \qquad ( 4 )$$

In these circumstances, as for the neighboring pixels of the feature point Fᵢ, the weight Wᵢ found from the matching rate of the relevant feature point is caused to act on the neighboring pixels. By reflecting the matching rate obtained from the feature point in the score of the image collation, an effect of improving the authentication accuracy may be obtained.

According to the present embodiment, the collation process between the feature points can be used for the narrowing process. Thereafter, by performing the image collation process that may obtain a more accurate authentication result, the authentication accuracy may be further enhanced.

In the present embodiment, history information on the matching rate (cumulative feature point matching rate C′ⱼ) of each feature point of the registration data may be utilized. The cumulative feature point matching rate C′ⱼ is a feature point matching rate (=an index as to whether or not the feature point is an ordinary feature) of each feature point of the registration data.

Specifically, C′ⱼ is found as follows. At the time of the collation process, the feature point matching rate Cᵢ of the feature point of the collation data corresponding to a j-th registered feature point in the registration data is obtained. A cumulative value C′ⱼ of this feature point matching rate Cᵢ is saved as a matching rate for the j-th registered feature point. A specific calculation method is assumed as C′ⱼ=βC′ⱼ+(1−β)Cᵢ, where the speed of training can be controlled by using a constant β. Note that i and j denote numbers given to paired feature points corresponding to the feature point of the collation data and the feature point of the registration data. The number given to the feature point of the collation data is denoted by i, and the number given to the feature point of the registration data is denoted by j.

Since the cumulative feature point matching rate C′ⱼ is a cumulative result of a plurality of times of the authentication process, it can be said that the cumulative feature point matching rate C′ⱼ is a more stable value than the feature point matching rate Cᵢ calculated from one time of authentication. The cumulative feature point matching rate C′ⱼ is updated in accordance with the above formula, but a configuration in which the update is stopped after a predetermined number of times of authentication may be adopted. Alternatively, a configuration in which the update is stopped at the time point when the stability of the cumulative feature point matching rate C′ⱼ can be confirmed (example: a change rate of C′ⱼ has become equal to or less than a predetermined threshold value) may be adopted. Stopping the update at the time point when the stable C′ⱼ is obtained may implement a stable authentication process, and additionally, an effect of reducing the burden of the collation process may be obtained.

In the present embodiment, by using the two matching rates of the feature point matching rate Cᵢ of the collation feature point and the cumulative feature point matching rate C′ⱼ of the registered feature point, a more accurate authentication process may be implemented.

Specifically, a registered feature point whose cumulative feature point matching rate C′ⱼ exceeds a predetermined threshold value is configured to be excluded from the collation processing object. Since the cumulative feature point matching rate is the past cumulative data, it is considered that the cumulative feature point matching rate is more reliable (than the feature point matching rate Cᵢ obtained for the collation data). The feature point of which this cumulative feature point matching rate C′ⱼ is high is considered to be a feature point that is not suitable for authentication with a high probability. By excluding such a feature point from the collation process, high authentication accuracy and a high-speed effect may be implemented.

After a feature point having a high cumulative feature point matching rate C′ⱼ is excluded, a collation scheme similar to the collation scheme of the first embodiment using the feature point matching rate Cᵢ can be applied. Alternatively, a configuration in which the cumulative feature point matching rate C′ⱼ is reflected in the final score may be adopted.

In the present embodiment, after the feature point collation is performed, a collation process with images is performed. Various methods can be considered for the collation process with images, but a scheme of calculating the similarity between images is usually used.

By saving the cumulative feature point matching rate C′ⱼ of the registration data, the high accuracy effect according to the present invention may be obtained not only at the time of the 1:N authentication but also at the time of the 1:1 authentication. For example, a configuration in which normal entrance and exit is performed by the 1:N authentication, but higher security is obtained for a server room or the like where high security is expected, by performing 1:1 authentication with an integrated circuit (IC) card+biometric authentication may be adopted. At this time, by performing the 1:1 authentication using the cumulative feature point matching rate C′ⱼ of the registration data obtained in the 1:N authentication process, more accurate authentication may be performed.

(Hardware Configuration)

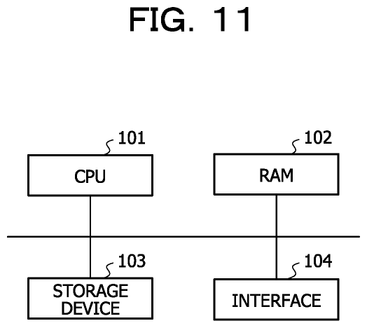

FIG. 11 is a block diagram illustrating a hardware configuration of the overall management unit 10, the database unit 20, the memory unit 30, the feature extraction unit 40, the collation processing unit 50, and the acquisition unit 60 of the information processing device 100 or the information processing device 100a. As illustrated in FIG. 11, the information processing devices 100 and 100a include a CPU 101, a RAM 102, a storage device 103, an interface 104, and the like.

The central processing unit (CPU) 101 is a central processing device. The CPU 101 includes one or more cores. The random access memory (RAM) 102 is a volatile memory that temporarily stores a program to be executed by the CPU 101, data to be processed by the CPU 101, and the like. The storage device 103 is a nonvolatile storage device. For example, a read only memory (ROM), a solid state drive (SSD) such as a flash memory, a hard disk to be driven by a hard disk drive, or the like can be used as the storage device 103. The storage device 103 stores an authentication program. The interface 104 is an interface device with an external device. The overall management unit 10, the database unit 20, the memory unit 30, the feature extraction unit 40, the collation processing unit 50, and the acquisition unit 60 of the information processing device 100 or 100a are implemented by the CPU 101 executing the authentication program. Note that hardware such as a dedicated circuit may be used as the overall management unit 10, the database unit 20, the memory unit the feature extraction unit 40, the collation processing unit 50, and the acquisition unit 60.

In each of the above examples, the matching rate calculation unit 54 is an example of a specifying unit that, when receiving biometric information from a user, specifies a plurality of feature points corresponding to the feature points included in the received biometric information, from among a plurality of feature points included in the plurality of registered pieces of the biometric information. The weight calculation unit 55 is an example of a determination unit that determines the degree of influence, on the authentication result of the user, of the similarity between features of the feature points included in the received biometric information and each of the features of the plurality of specified feature points, based on the similarity between each of the features of the specified plurality of feature points and each of the features of the corresponding feature points included in the received biometric information. The collation management unit 51 is an example of an authentication unit that accumulates and records a ratio of the number of the feature point pairs to the number of the plurality of registered pieces of the biometric information, for each of the corresponding feature points included in the plurality of registered pieces of the biometric information, and uses the accumulated and recorded ratio for the authentication result of the user. The image collation unit 56 is an example of an image collation unit that uses the degree of influence for collation between biometric images from which the received biometric information has been extracted and a plurality of biometric images that are registered.

While the embodiments of the present invention have been described above in detail, the present invention is not limited to such particular embodiments, and a variety of modifications and alterations can be made within the scope of the gist of the present invention described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An authentication method for a computer to execute a process comprising:
when receiving biometric information from a user, specifying a plurality of feature points that correspond to feature points included in the received biometric information, from among feature points included in a plurality of registered pieces of biometric information; and
determining a degree of influence, on an authentication result of the user, of similarity between features of the feature points included in the received biometric information and each of the specified plurality of feature points, based on the similarity between each of the specified plurality of feature points and each of the feature points included in the received biometric information.

2. The authentication method according to claim 1, wherein the specified plurality of feature points is feature points whose distances from the feature points included in the received biometric information are equal to or less than a threshold value, among the feature points included in the plurality of registered pieces.

3. The authentication method according to claim 1, wherein the determining includes determining the degree of influence, based on a number of feature point pairs in which the similarity between each of the specified plurality of feature points and each of the feature points included in the received biometric information is equal to or higher than a threshold value.

4. The authentication method according to claim 3, wherein the determining includes determining the degree of influence, based on a ratio of the number of the feature point pairs to a number of the plurality of registered pieces of the biometric information.

5. The authentication method according to claim 3, wherein the determining includes lessening the degree of influence as the number of the feature point pairs increases.

6. The authentication method according to claim 4, wherein the process further comprising:
recording the ratio for each of the feature points included in the plurality of registered pieces of the biometric information; and
using the recorded ratio for the authentication result of the user.

7. The authentication method according to claim 1, wherein the process further comprising
using the degree of influence for collation between biometric images from which the received biometric information has been extracted and a plurality of the biometric images that are registered.

8. The authentication method according to claim 1, wherein the biometric information is one selected from vein information and fingerprint information.

9. An information processing device comprising:
one or more memories; and
one or more processors coupled to the one or more memories and the one or more processors configured to:
when receiving biometric information from a user, specify a plurality of feature points that correspond to feature points included in the received biometric information, from among feature points included in a plurality of registered pieces of biometric information, and
determine a degree of influence, on an authentication result of the user, of similarity between features of the feature points included in the received biometric information and each of the specified plurality of feature points, based on the similarity between each of the specified plurality of feature points and each of the feature points included in the received biometric information.

10. A non-transitory computer-readable storage medium storing an authentication program that causes at least one computer to execute a process, the process comprising:
when receiving biometric information from a user, specifying a plurality of feature points that correspond to feature points included in the received biometric information, from among feature points included in a plurality of registered pieces of biometric information; and
determining a degree of influence, on an authentication result of the user, of similarity between features of the feature points included in the received biometric information and each of the specified plurality of feature points, based on the similarity between each of the specified plurality of feature points and each of the feature points included in the received biometric information.

11. The non-transitory computer-readable storage medium according to claim 10, wherein the specified plurality of feature points is feature points whose distances from the feature points included in the received biometric information are equal to or less than a threshold value, among the feature points included in the plurality of registered pieces.

12. The non-transitory computer-readable storage medium according to claim 10, wherein the determining includes determining the degree of influence, based on a number of feature point pairs in which the similarity between each of the specified plurality of feature points and each of the feature points included in the received biometric information is equal to or higher than a threshold value.

13. The non-transitory computer-readable storage medium according to claim 12, wherein the determining includes determining the degree of influence, based on a ratio of the number of the feature point pairs to a number of the plurality of registered pieces of the biometric information.

14. The non-transitory computer-readable storage medium according to claim 12, wherein the determining includes lessening the degree of influence as the number of the feature point pairs increases.

15. The non-transitory computer-readable storage medium according to claim 13, wherein the process further comprising:
recording the ratio for each of the feature points included in the plurality of registered pieces of the biometric information; and
using the recorded ratio for the authentication result of the user.

16. The non-transitory computer-readable storage medium according to claim 10, wherein the process further comprising
using the degree of influence for collation between biometric images from which the received biometric information has been extracted and a plurality of the biometric images that are registered.

17. The non-transitory computer-readable storage medium according to claim 10, wherein the biometric information is one selected from vein information and fingerprint information.
